(19) United States
(12) Patent Application Publication
(10) Pub. No.: US 2025/0112375 A1
(43) Pub. Date: Apr. 3, 2025

(54) BACKFIRE AXIAL MODE ANTENNA

(71) Applicant: MacDonald, Dettwiler and Associates Corporation, Sainte-Anne-de-Bellevue (CA)

(72) Inventors: Nicholas Boudreau, Vaudreuil-Dorion (CA); Santiago Sierra-Garcia, Montreal (CA); Stéphane Lamoureux, Mirabel (CA); Thomas Tralman, Whitby (CA); Steve Larouche, Saint-Lazare (CA)

(21) Appl. No.: 18/897,498

(22) Filed: Sep. 26, 2024

Related U.S. Application Data
(60) Provisional application No. 63/586,698, filed on Sep. 29, 2023.

(51) Int. Cl. H01Q 11/08; H01Q 1/36; H01Q 1/48

(52) U.S. Cl. CPC H01Q 11/083; H01Q 1/362; H01Q 1/48

(57) ABSTRACT

An antenna system is provided. The antenna system includes a base structure, a transmission line, a ground plane, and a backfire antenna element. The transmission line extends from the base structure and is coupled to the base structure at a first end of the transmission line. The ground plane is coupled to the transmission line at a second end of the transmission line. The backfire antenna element extends between the ground plane and the base structure. The backfire antenna element is coupled to the second end of the TEM line.

### TECHNICAL FIELD

The following relates generally to antennas, and more particularly to systems and methods for backfire axial mode helical antennas.

### INTRODUCTION

Helical antennas, which are generally fed with a signal from the base or bottom, may be used for a wide range of RF applications. In certain applications, space and volume constraints may limit the use of helical antennas. Similarly, the application environment of helical antennas may be crowded or otherwise contain conductive materials. The presence of such objects and/or materials may result in RF signal scattering when using helical antennas in these environments.

Accordingly, there is a need for an improved system and method for helical antennas that overcome at least some of the disadvantages of existing systems and methods.

### SUMMARY

An antenna system is provided. The antenna system comprises: a base structure; a transmission line extending from the base structure, the transmission line coupled to the base structure at a first end of the transmission line; a ground plane coupled to the transmission line at a second end of the transmission line; and a backfire antenna element between the ground plane and the base structure; wherein the backfire antenna element is coupled to the second end of the transmission line.

In an embodiment, the backfire antenna element is helical.

In an embodiment, the system further comprising a transmission line, wherein the transmission line is a TEM line.

In an embodiment, the system further comprising a transmission line, wherein the transmission line is a microstrip line.

In an embodiment, the system further comprising a transmission line, wherein the transmission line is a coaxial cable.

In an embodiment, the system further comprising a transmission line, wherein the transmission line is a dielectric loaded waveguide.

In an embodiment, the system further includes a dielectric support structure, wherein the helical antenna element is coupled to the dielectric support structure.

In an embodiment, the dielectric support structure is constructed from a dielectric material.

In an embodiment, the backfire antenna element includes a rectangular cross section.

In an embodiment, the backfire antenna element is constructed from a conductive material.

In an embodiment, the transmission line includes a matching network.

In an embodiment, the matching network includes a quarter-wave transformer, or stub.

In an embodiment, the transmission line includes a center conducting ground stub.

In an embodiment, the base structure is constructed from a metallic material.

In an embodiment, the antenna system is configured to transmit and/or receive UHF frequency signals.

In an embodiment, the system may be configured to allow for relative thermal displacement between the antenna element and dielectric support structure.

In an embodiment, the transmission line further includes a support structure for supporting the ground plane and the antenna element.

In an embodiment, the antenna system may be coupled to a spacecraft.

A method of transmitting an RF signal through an antenna system is also provided. The method includes providing an RF signal to an antenna system as an input; transmitting the RF signal through a transmission line of the antenna system, the transmission line comprising an impedance matching network; transmitting the RF signal through a helical antenna element having an axial center; and radiating the RF signal away from the antenna system through the helical antenna element, wherein the transmission line is positioned at the axial center of the helical antenna element.

In an embodiment, the transmission line is a TEM line.

In an embodiment, the transmission line is a microstrip line.

In an embodiment, the transmission line is a coaxial cable.

In an embodiment, the transmission line is a dielectric loaded waveguide.

In an embodiment, the transmission line comprises a matching network.

In an embodiment, the matching network comprises a quarter-wave transformer, or stub.

In an embodiment, the antenna element comprises a rectangular cross section.

In an embodiment, the antenna element is constructed from a conductive metallic material.

In an embodiment, the antenna system is configured to at least one of: transmit UHF frequency signals; and receive UHF frequency signals.

In an embodiment, the antenna system is coupled to a spacecraft.

The systems and methods for backfire axial mode helical antennas described herein may reduce the antenna footprint and reduce scattering impacts when operating at UHF frequencies.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a perspective view of a backfire helical antenna, according to an embodiment;

FIG. 2 is a front view of a backfire helical antenna, according to another embodiment; and

FIG. 3 is a flow chart depicting a method of operating the antenna system of FIGS. 1-2, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

Described herein is a backfire mode helical antenna, wherein the antenna is fed from the extreme opposite end of the helical element that extends away from the base of the antenna, versus a front fire mode helical antenna, wherein the antenna is fed at the nearest end of the helical element. In contrast to front fire axial mode helical antennas, the backfire mode helical antenna may provide acceptable performance at a decreased physical size, and may be less susceptible to signal scattering impacts. By packaging antenna components within the typically open volume of the antenna element helix, antenna packaging may be made even more efficient, further reducing the overall volume and footprint of the antenna, which may be particularly advantageous when applied to space environments. In contrast, a traditional front fire mode helical antenna may require matching network components to be placed outside the open internal volume of the antenna, increasing the required volume of the antenna.

In a front fire helical antenna configuration, the ground plane for the antenna element helix is typically at least 0.5 wavelengths in diameter. However, as the ground plane is made smaller, the front-to-back ratio degrades rapidly to 0 dB and then becomes dominant and transitions to a nearly pure backfire radiation.

At UHF bands, the wavelength is so large that when the antenna footprint or real estate available (e.g. on the spacecraft to which the antenna is coupled) is not sufficient to have a large enough ground plane, the conditions where the backfire radiation occurs become non-negligible.

To overcome this situation the antenna system described herein is a backfire antenna by design, wherein the ground plane size is intentionally kept small enough to generate backfire radiation. This ground plane is located at the top of the antenna system next to its feeding point. An optimization of the ground plane size is resulting in low front fire radiation which in turn is resulting in a lower RF scattering impact (e.g. from a spacecraft to which the antenna system is coupled).

An optimization of the helix diameter and pitch angle results in the radiation of a circularly polarized electromagnetic field over the chosen frequency band and coverage area.

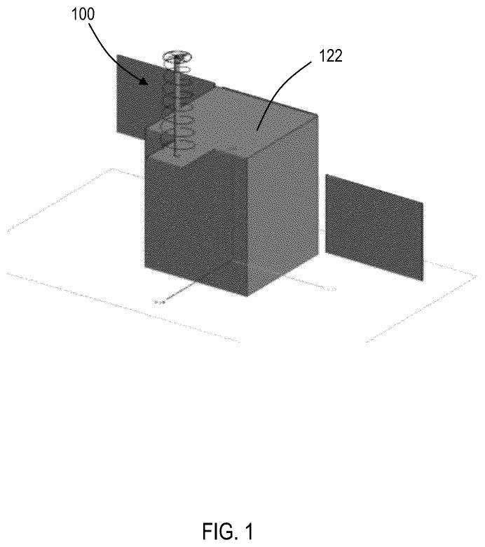

Referring first to FIG. 1, pictured therein is a perspective view of a backfire mode helical antenna system 100, for transmitting and/or receiving radio frequency (RF) signals, according to a certain radiation pattern. The radiation pattern associated with antenna system 100 herein generally aligns with the typical radiation pattern of helical antennas. Antenna system 100 is configured to transmit and/or receive ultra-high frequency (UHF) band RF signals. In other embodiments, antenna system 100 may be configured to transmit and/or receive different RF bands. In such variations, the overall and relative dimensions of antenna system 100 may be varied to provide performance at other RF bands.

As seen in FIG. 1, antenna system 100 is coupled to a base object 122, using mechanical fasteners, or other coupling means. Base object 122 is near antenna system 100, such that the presence of base object 122 may interfere with, and/or scatter RF signals transmitted or received by antenna system 100, such that the expected and desired radiation pattern associated with antenna system 100 is disturbed, reducing RF performance. In the embodiment of FIG. 1, base object 122 is a satellite, which is configured to communicate with other objects or systems using RF signals. In other embodiments, base object 122 may be a space station, spacecraft, vehicle, building, radio tower, or any other object which may require or advantageously include RF communication capabilities. Antenna system 100 is particularly configured to operate in space environments, and is accordingly configured to tolerate radiation and thermal cycling which may occur in space environments. Further, antenna system 100 is optimized to reduce space and volume requirements, which may be particularly advantageous in space applications wherein volume may be limited by launch vehicle space and/or cost.

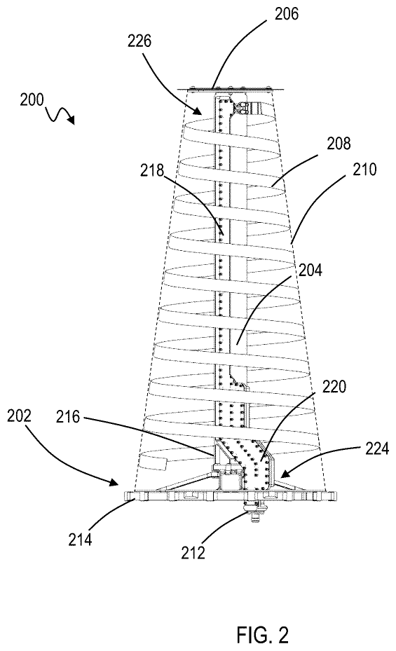

Referring now to FIG. 2, pictured therein is a front detail view of an alternate embodiment, antenna system 200, of antenna system 100 of FIG. 1. Antenna system 200 is a backfire mode helical antenna, wherein the feeding point is provided to the helical antenna element at the extreme end of the helical element, versus the nearest point of the helical element, as expected from a front fire mode helical antenna. Antenna system 200 comprises support structure 202 for mechanically supporting the antenna system 200, transverse electromagnetic (TEM) line 204 for transmitting and/or receiving RF signals to and/or from the ribbon 208, ground plane 206 for providing a grounded area of antenna system 200, ribbon 208 which acts as the helical antenna radiating element, dielectric support structure 210 which provides further mechanical support to antenna system 200 and TNC connector 212 for coupling antenna system 200 to an RF signal source and/or receiver.

Support structure 202 comprises a mechanical structure for supporting components of antenna system 200. Support structure 202 includes base 214, having a generally cylindrical shape, and central support 216 extending perpendicularly from the base 214 to provide a central, vertical support for antenna system 200 components, including dielectric support structure 210, TEM line 204, ground plane 206 and ribbon 208. Support structure 202 may be constructed as a single integrated component, for example, using additive manufacturing, such as selective laser sintering. In other examples, support structure 202 may comprise a multi-component assembly, wherein base 214 and central support 216 are separate components which may be coupled to one another, using, for example, a mechanical fastener such as a machine screw.

TEM line 204 comprises a transmission line and/or a conductive path through which an RF signal is transmitted and/or received to ribbon 208, to feed the RF signal at the extreme end of ribbon 208, such that system 200 operates in a backfire mode arrangement. TEM line 204 may include a plurality of conductors and/or conductor paths. TEM line 204 extends from base 214 to ground plane 206. As used herein, a backfire mode refers to the arrangement wherein the signal is fed at the extreme end of ribbon 208, versus the nearest point of ribbon 208 to TNC connector 212. TEM line 204 carries electromagnetic signals propagating in transverse electromagnetic mode. TEM line 204 is generally positioned at the axial center of ribbon 208 helix, allowing for compact packaging of system 200. The positioning of TEM line 204 within the axial center of ribbon 208 helix does not significantly impact RF performance and/or the radiating field versus configurations wherein the TEM line 204 is positioned outside of the ribbon 208 helix.

TEM line 204 comprises a first end 224 and a second end 226. First end 224 is nearest to base 214, while second end 226 is nearest to ground plane 206. TEM line 204 feeds ribbon 208 proximate the second end 226 of TEM line 204.

Integrated into TEM line 204 is matching network 218. Matching network 218 comprises a set of microwave components, such as a quarter-wave transformer, stub, and/or other microwave components, for impedance matching of antenna system 200. By integrating matching network 218 into TEM line 204, antenna system 200 may be constructed more compactly, as less volume is required due to the use of the typically vacant volume within the helix of ribbon 208.

In an embodiment, central support 216 is integrated into TEM line 204, such that central support and TEM line 204 comprise a single integrated component, wherein TEM line 204 provides mechanical support to ribbon 208, dielectric support structure 210 and ground plane 206. In another embodiment, TEM line 204 may be coupled to central support 216 by fusing TEM line 204 to central support 216 using an adhesive. In other examples, TEM line 204 may be coupled to central support 216 through other means. Such an arrangement may reduce mass and volume requirements of system 200.

Integrated into TEM line 204 (e.g. as a specific conductor within the set of conductors present within TEM line 204) is grounding stub 220. Grounding stub 220 is a conductive component and is maintained at a neutral electrical potential. Grounding stub 220 is coupled to other grounded components to maintain these components at a neutral electrical potential. Grounding stub 220 provides an electrostatic discharge bleed path for the center conductor of TEM line 204. Grounding stub 220 may be ultimately coupled to a master ground of a vehicle, structure, spacecraft, satellite or other object to which antenna system 200 is coupled to.

In an embodiment, TEM line 204 may be particularly configured to tolerate thermal cycling, such that unequal thermal expansion of materials within TEM line 204 (e.g. flexible PCB components and metallic structural components) may be accounted for without resulting in damaging mechanical stresses. For example, voids or volumes may be present within TEM line 204 near areas wherein relative thermal expansion is expected, providing space for expansion to occur without generating mechanical strains and associated mechanical stresses. In another embodiment, other means or methods may be applied to account for thermal cycling and associated mechanical stresses.

In an embodiment, the transmission line may be a microstrip line, coaxial cable, a dielectric loaded waveguide or other suitable transmission line instead of a TEM line.

Ground plane 206 comprises a generally planar conductive structure, positioned at the end of ribbon 208, proximate the second end 226 of TEM line. Ground plane 206 is the grounded portion of antenna system 200. Ground plane 206 is coupled to TEM line 204 near second end 226 of TEM line 204.

Ground plane 206 is generally planar, however, in other embodiments, ground plane 206 may comprise differing forms, for example, a partial sphere, parabolic dish and/or other curved forms.

Ribbon 208 comprises an electrically conductive antenna element, arranged in a helix pattern, extending from base 214 to ground plane 206. Ribbon 208 is the element which transmits and/or receives radio frequency signals, wherein these signals are circularly polarized. In the present embodiment, ribbon 208 is particularly configured to receive and/or transmit UHF RF signals. In the present embodiment, ribbon 208 is a flat ribbon, having a rectangular cross section, however in other embodiments, ribbon 208 may comprise other cross sections, such as elliptical or circular cross sections. Ribbon 208 is arranged in a tapered or conical helical pattern, extending from base 214 to ground plane 206, however in other embodiments, ribbon 208 may be arranged in a cylindrical helical pattern, or a tapered helical pattern having different tapering angles or dimensions.

Ribbon 208 is coupled to TEM line 204 proximate the second end 226 of TEM line 204, for receiving and/or transmitting RF signals from/to TEM line 204.

Ribbon 208 comprises a conductive metallic helical ribbon. In other embodiments, other suitable conductive materials may be used to construct ribbon 208.

Dielectric support structure 210 comprises an RF transparent support material to which ribbon 208 is coupled to. Dielectric support structure 210 provides support and mechanical stability to antenna system 200. Dielectric support structure 210 has a generally conical shape, having dimensions such that the ribbon 208 circumference is equal to the wavelength and the ribbon 208 pitch angle around 13 degrees. In other embodiments, dimensions of dielectric support structure 210 and ribbon 208 may differ. For example, dielectric support structure 210 may comprise threads or ribbons instead of a conical sheet. Ribbon 208 is fused to dielectric support structure 210, such that ribbon 208 is maintained at the shape of dielectric support structure 210.

Dielectric support structure 210 is additionally coupled to base 214 and ground plane 206 to provide for greater mechanical stability for both dielectric support structure 210 and ribbon 208.

Dielectric support structure 210 is constructed from a glass cloth material impregnated with epoxy resin. The dielectric material is RF transparent in the UHF range. Dielectric support structure 210 generally maintains its shape and dimensions under its own weight, due to the structural characteristics of its dielectric material. In other embodiments, Dielectric support structure 210 may be constructed from other materials having similar mechanical and electrical properties.

While in the present embodiment, dielectric support structure 210 comprises a conical form, cone 210 may be swapped out for a similar support structure having a different shape in other embodiments, such as a cylindrical support.

In some examples, dielectric support structure 210 and ribbon 208 may be coupled in a manner allowing for relative thermal expansion of each component while minimizing mechanical stresses associated with this thermal expansion with differing coefficients of thermal expansion between dielectric support structure 210 and ribbon 208. For example, dielectric support structure 210 and ribbon 208 may only be coupled (e.g. using an adhesive) at the base of dielectric support structure 210, proximate the first end 224 of TEM line 204, allowing for thermal expansion upwards towards the second end 226 of TEM line 204. In other examples, other methods of accounting for thermal expansion may be present.

Threaded Neill-Concelman (“TNC”) connector 212 is an electromechanical connector to which a signal feed line may be connected to antenna system 200. TNC connector 212 is coupled to TEM line 204, such that the input signal fed into TNC connector 212 is directed to, and conducted through TEM line 204. As previously described, signals input into (or received from, in receive mode operations) TNC connector 212 may be propagating in transverse electromagnetic mode.

While a TNC connector is used herein, in other embodiments, other electromechanical connectors, such as Bayonet Neill-Concelman (“BNC”) connectors, SubMiniature version A (“SMA”) connectors, or other suitable RF connectors may be used.

In operation, TNC connector 212 is coupled to an input conductor, to provide system 200 with an RF signal. This signal is passed upwards through TEM line 204, wherein the signal is impedance matched by matching network 218. This signal is then passed from TEM line 204 to ribbon 208, which then radiates or transmits the signal away from antenna system 200, for reception by another antenna system operating in receive mode. In an embodiment, this operation may be conducted in reverse to operate system 200 in receive mode instead of transmit mode. Due to the backfire mode physical arrangement of antenna system 200, signal scattering impacts are reduced, improving predictability of antenna system 200 performance in examples wherein antenna system 200 is positioned near possibly scattering surfaces, such as spacecraft components. Further, due to the backfire mode arrangement, antenna system 200 is able to be constructed with a smaller volume, as previously described herein.

In comparison to a front fire axial mode helical antenna, wherein the input signal to the ribbon 208 is input near the base of the ribbon 208, the backfire mode helical antenna described herein provides for acceptable performance, and a broader radiation pattern with a smaller physical size (e.g. reduced diameter and/or length of ribbon 208), as components such as TEM line 204 may be integrated within the open volume of ribbon 208. The impact of the presence of TEM line 204 and other components in this position to the radiation pattern and overall RF performance is negligible.

Additionally, the antenna system 200 described herein is robust to temperature cycling, due to the relative arrangement of dielectric support structure 210 and ribbon 208, as well as the coupling of TEM line 204 and central support 216. Further, by packaging TEM line 204, including matching network 218 and central support 216, within the internal diameter of dielectric support structure 210 and ribbon 208, system 200 may be made compact, which may be advantageous in space applications as previously described herein, such as coupling system 200 to a spacecraft.

While the antenna system 200 described herein is configured for use in space applications, and for operation in UHF frequency ranges, in other embodiments, system 200 may be configured for other applications (e.g. terrestrial applications on buildings, vehicles and/or radio towers), and for operation in other RF bands. In such examples, the dimensions of system 200 may be varied to provide performance in other RF bands.

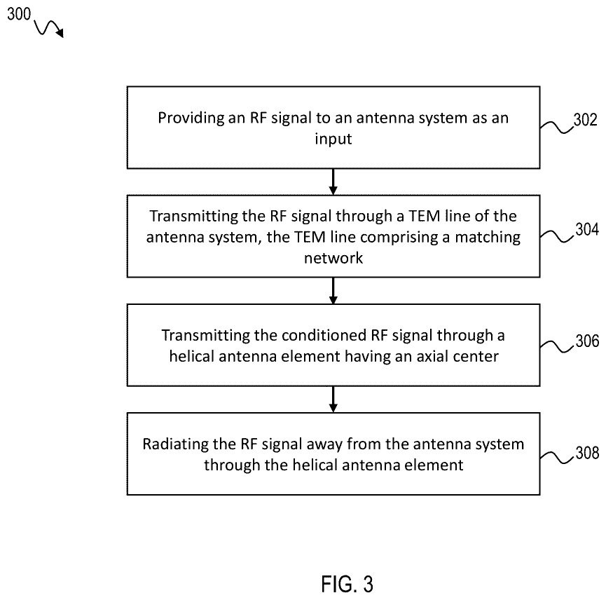

Referring now to FIG. 3, pictured therein is a flowchart depicting a method 300 of using the antenna systems of FIGS. 1 to 2. Method 300 includes 302, 304, 306 and 308.

At 302, an RF signal is provided to an antenna system as an input.

At 304, the RF signal is transmitted through a TEM line of the antenna system, the TEM line comprising a matching network.

At 306, the RF signal is transmitted through a helical antenna element having an axial center.

At 308, the RF signal is transmitted away from the antenna system through the helical antenna element.

While the disclosure herein is directed to helical backfire antenna systems, in other embodiments, the antenna system may comprise backfire antennas of other forms, for example, bifilar or quadrifilar antennas.

While the above description provides examples of one or more apparatus, methods, or systems, it will be appreciated that other apparatus, methods, or systems may be within the scope of the claims as interpreted by one of skill in the art.

1. An antenna system, the system comprising:
a base structure;
a transmission line extending from the base structure, the transmission line coupled to the base structure at a first end of the transmission line;
a ground plane coupled to the transmission line at a second end of the transmission line; and
a backfire antenna element between the ground plane and the base structure;
wherein the backfire antenna element is coupled to the second end of the transmission line.

2. The system of claim 1, wherein the backfire antenna element is helical.

3. The system of claim 1, the system further comprising a transmission line, wherein the transmission line is a TEM line, a microstrip line, a coaxial cable, or a dielectric waveguide.

4. The system of claim 1, the system further comprising a dielectric support structure, wherein the helical antenna element is coupled to the dielectric support structure.

5. The system of claim 4, wherein the dielectric support structure is constructed from a dielectric material.

6. The system of claim 1, wherein the backfire antenna element comprises a rectangular cross section.

7. The system of claim 1, wherein the backfire antenna element is constructed from a conductive metallic material.

8. The system of claim 1, wherein the transmission line comprises a matching network.

9. The system of claim 8, wherein the matching network comprises a quarter-wave transformer, or stub.

10. The system of claim 1, wherein the transmission line comprises a center conducting ground stub.

11. The system of claim 1, wherein the base structure is constructed from a metallic material.

12. The system of claim 1, wherein the antenna system is configured to at least one of: transmit UHF frequency signals; and receive UHF frequency signals.

13. The system of claim 1, wherein the system is configured to allow for relative thermal displacement between the antenna element and dielectric support structure.

14. The system of claim 1, wherein the transmission line further comprises a support structure for supporting the ground plane and antenna element.

15. A method of transmitting an RF signal through an antenna system, the method comprising:
providing an RF signal to an antenna system as an input;
transmitting the RF signal through a transmission line of the antenna system, the transmission line comprising an impedance matching network;
transmitting the RF signal through a helical antenna element having an axial center; and
radiating the RF signal away from the antenna system through the helical antenna element,
wherein the transmission line is positioned at the axial center of the helical antenna element.

16. The method of claim 15, wherein the transmission line is a TEM line, a microstrip line, a coaxial cable, or a dielectric loaded waveguide.

17. The method of claim 15, wherein the transmission line comprises a matching network comprising a quarter-wave transformer or stub.

18. The method of claim 15, wherein the antenna element comprises a rectangular cross section.

19. The method of claim 15, wherein the antenna element is constructed from a conductive metallic material.

20. The method of claim 15, wherein the antenna system is configured to at least one of: transmit UHF frequency signals; and receive UHF frequency signals.
